(19) United States
(12) Patent Application Publication
(10) Pub. No.: US 2016/0078696 A1
(43) Pub. Date: Mar. 17, 2016

(54) ACCESS METHOD AND SYSTEM WITH WEARABLE CONTROLLER

(71) Applicant: Zhigang Fan, San Jose, CA (US)

(72) Inventor: Zhigang Fan, San Jose, CA (US)

(73) Assignee: SKR LABS, LLC, Webster, NY (US)

(21) Appl. No.: 14/846,990

(22) Filed: Sep. 7, 2015

Related U.S. Application Data
(60) Provisional application No. 62/050,285, filed on Sep. 15, 2014.

(51) Int. Cl. G07C 9/00

(52) U.S. Cl. CPC G07C 9/00039; G07C 9/00111

(57) ABSTRACT

A control system and method for vehicle/house entry system with a wearable controller. A distance is determined between said control system and said vehicle or house. A message is prompt requesting for unlocking in a user interface in said controller if said distance is smaller than a threshold. A message is communicated with said vehicle or house requesting for unlocking if said prompted message is confirmed.

### CROSS-REFERENCE TO RELATED APPLICATION

This application hereby claims priority under 35 U.S.C. .sctn.119 to U.S. Provisional Patent Application No. 62050285 filed Sep. 15, 2014, entitled “Access Method and System with Wearable Controller,” the disclosure of which is incorporated herein by reference.

### TECHNICAL FIELD

Embodiments are generally related to vehicle and house entry methods and systems. Embodiments are further related to a vehicle and house entry method and system with a wearable control mechanism.

### BACKGROUND OF THE INVENTION

Smart phones are changing our lives: the way we think, the way we plan and certainly the way we use our cars and living in our houses. Various car apps and home apps have been developed that provide users with functions such as navigation, entertainment, driving assistance, and control. Utilizing the communication capability contained in smart phones, many car/home apps are capable of communicating with the vehicle and home devices anytime, anywhere and providing the function of remote control. As an example, with the Tesla Model S Beta app, the users can check charging progress in real time and start or stop charge, heat or cool the vehicle before driving, local the vehicle with directions or track its movement across a map, flash lights or honk the horn to find vehicle when parked, and lock or unlock the vehicle from afar.

While these control functions provide with convenience, the users typically still need to: 1) search for their smart phone in their pocket or purse; 2) find the app in the phone; 3) start the app (by pushing the icon associated with the app); and 4) locate and push the button associated with the action (for example unlocking the door). This is particularly inconvenient for unlocking vehicles and house doors, when hands are often fully occupied.

Wearable technology features computing devices that are wearable in the forms of watches, glasses, caps, etc. The emergence of wearable tech such as Apple Watch may provide similar functions as smart phones, but with more convenience. For example, users do not need to search for their Apple Watch, while they are wearing it. However, to unlock their vehicle or house doors, they still need to: 1) find the app in the watch; 2) start the app (by pushing the icon or button associated with the app); and 3) locate and push the button associated with the action. Given the small size of a watch, to locate the app in the watch and start it could not be very easy.

Thus, there is need for further improving the convenience for vehicle or house entry systems with a wearable controller, in particular, for removing or simplifying the steps of 1) finding the app in the watch; 2) starting the app; and 3) locating and pushing the button associated with the action.

### BRIEF SUMMARY

In one general respect, the embodiments disclose a control system and method for vehicle/house entry system with a wearable controller. A distance is determined between said control system and said vehicle or house. A message is prompt requesting for unlocking in a user interface in said controller if said distance is smaller than a threshold. A message is communicated with said vehicle or house requesting for unlocking if said prompted message is confirmed.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram depicting a vehicle/house entry system in accordance with an embodiment of a present teachings;

FIG. 2 illustrates a block diagram depicting a wearable controller for vehicle/house entry system in accordance with an embodiment of a present teachings;

FIG. 3 illustrates a flow chart depicting a method in accordance with an embodiment of a present teachings.

### DETAILED DESCRIPTION

This disclosure pertains to a vehicle/house entry method and system with a wearable controller. While this disclosure discusses a new technique for vehicle/house entry method and system with a wearable controller, one of ordinary skill in the art would recognize that the techniques disclosed may also be applied to other contexts and applications as well.

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

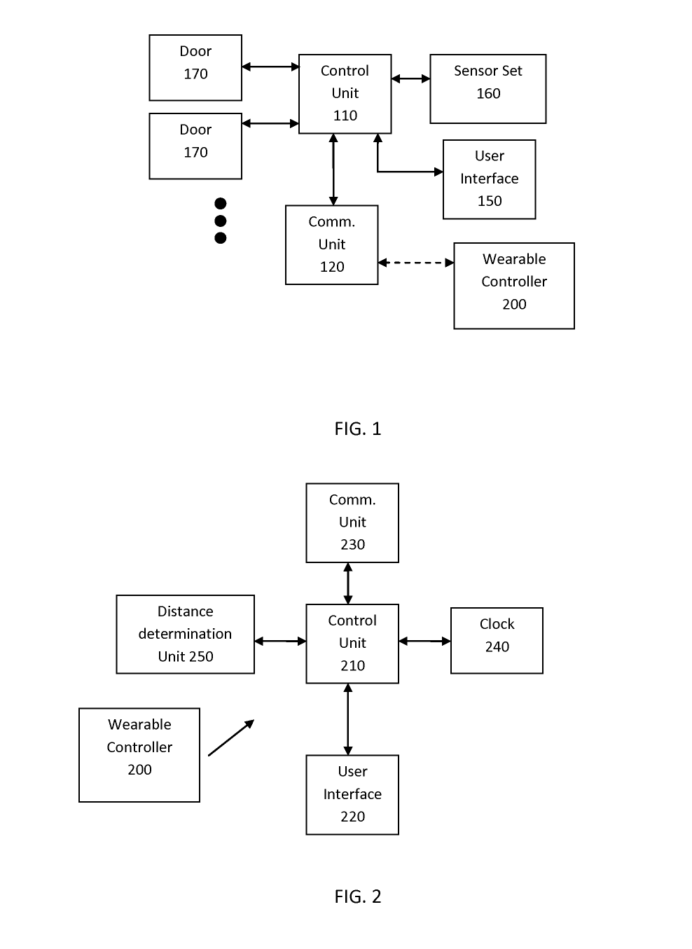

Referring now to FIG. 1, a block diagram of a vehicle/house entry system used to illustrate an example embodiment in which several aspects of the present invention may be implemented. The system is shown containing control unit 110, communication unit 120, user interface 150, sensor set 160, door units 170, and wearable controller 200. Only the components as pertinent to an understanding of the operation of the example embodiment are included and described, for conciseness and ease of understanding. Each component of FIG. 1 is described in detail below.

Control unit 110 may contain one or more processors, or other logic circuits, with memory or other storage devices.

Communication unit 120 transmits information to a wearable controller 200, according to control unit's instructions. It also receives information from wearable controller 200 and passes it to control unit 110. An example of communication unit to be applied here is a Bluetooth device. The Bluetooth is a short range radio communication system. They may send/receive signal to/from another Bluetooth device in a range of one meter to one hundred meters. Another example of communication unit is Wifi, which is a local area wireless technology that allows an electronic device to exchange data or connect to internet using radio waves.

User interface 150 may contain a screen and a sound output devices showing various user instructions as well as status information and warn signals. It may also contains various buttons and other input mechanisms that receives instructions from the user. The user interface may physically reside with the vehicle/house, or reside with a remote device such as a mobile phone or wearable controller, and exchange information with control unit 110 through a communication link.

Sensor set 160 contains different sensors detecting various user actions and status of various parts of the system. It may include a sensor in a door handle for detecting if the door handle is being gripped (for indicating user's intention of unlocking the door). It may also include a sensor in a door handle for detecting if a locking-door button on the door handle is being pushed (for indicating user's intention of locking the door). It may include a sensor detecting if a door is currently locked or unlocked.

Wearable controller 200 is able to communicate with communication unit 120.

Referring now to FIG. 2, a block diagram of a wearable controller used to illustrate an example embodiment in which several aspects of the present invention may be implemented. The wearable controller 200 is shown containing control unit 210, user interface 220, communication unit 230, clock 240, and distance determination unit 250.

Control unit 210 may contain one or more processors, or other logic circuits, with memory or other storage devices.

User interface 220 may contain a screen and a sound output devices showing various user instructions as well as status information and warn signals. It may also contains various buttons and other input mechanisms that receives instructions from the user.

Communication unit 230 transmits information to the communication unit 120 in vehicle/house, according to control unit's instruction. It also receives information from the communication unit 120 in vehicle/house and passes it to control unit 210.

Clock 240 provides control unit 210 with the current time information. It and can be set by control unit 210.

Distance determination unit 250 determines the relative distance between the wearable control and the vehicle/house. In one embodiment of present invention, the distance is determined using Bluetooth communication. The Bluetooth device functions in a range of one meter to one hundred meters. The strength of the received Bluetooth radio signal exchanged between the wearable controller and the vehicle/house indicates a rough distance between the controller and the vehicle/house. In another embodiment of present invention, the position of the wearable controller is estimated using a GPS (Global Positioning System) system or other position means. The relative distance between the wearable control and the vehicle/house is determined by comparing the positions of the wearable controller and the vehicle/house. In yet another embodiment of present invention, the distance is determined by transmitting an acoustic signal by one party (wearable control or vehicle/house) and receiving by another party (vehicle/house or wearable control) and measuring the time lapse between transmission and receiving. In yet another embodiment of present invention, the distance is determined by a combination of more than one technology, for example, using Bluetooth or GPS for a crude distance measurement and using acoustic signal for a refined measurement. The distance determination unit 250 may share components with other parts of the system. For example, the Bluetooth used for distance measurement may also be used for communication.

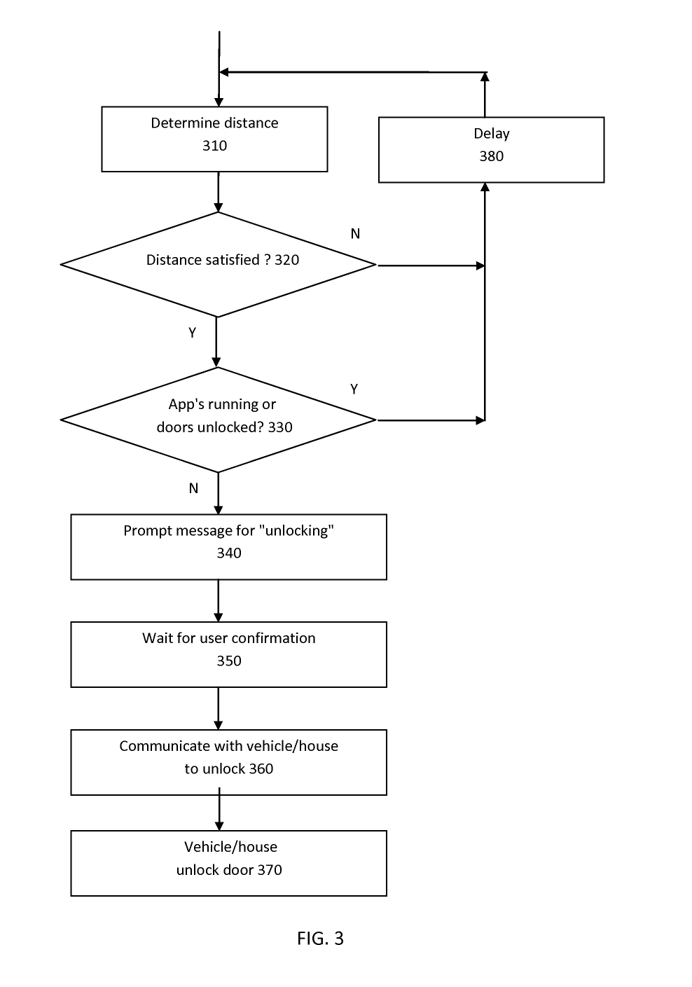

Referring now to FIG. 3, a block diagram depicting a method in accordance with an embodiment of a present teachings. In one embodiment of present invention, the method is implemented as an app residing in the wearable controller, running at background. An app can run in foreground or in background. The foreground mode is the normal mode, in which the app can access user interface. Apps running in background mode cannot access the user interface, but can still perform certain functions such as handling Bluetooth- and GPS-related events, alert user with prompted messages.

In block 310, the distance between the wearable controller and the vehicle/house is determined with distance determination unit 250. In block 320, the distance measured is checked to see if the wearable controller (and thus its owner) is within a pre-determined distance to the vehicle/house. By continuing measuring the distance, it may further be determined if the owner of the wearable controller is approaching or leaving the vehicle/house. If the user is approaching the vehicle/house and the distance is close enough (smaller than the pre-determined threshold (yes in block 320), the process proceeds to step 330. Otherwise (no in block 320), the control moves to step 380 for a short delay (say a few seconds), and starts another round of distance measuring (310). Block 330 is optional. In block 330, it is checked if there is an app currently running in foreground, and if the door is already unlocked. If an app is running in foreground (e.g. the user is browsing internet), the user may not like to be interrupted. If the door is already unlocked, there is no need to be unlocked again. If either of above two conditions is true (yes in block 330), the control moves to block 380 to start another iteration after a delay. If both conditions are false (no in block 330), a message is prompt to the user interface (220) of the wearable controller, asking if the user intents to unlock the door (step 340). If the user confirms unlocking in step 350, the wearable controller exchanges identification/authentication and other information with the vehicle/house via communication units 230 and 120 (step 360). After a positive identification/authentication, the control unit (110) unlocks the door (step 370).

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A control system for vehicle and house entry comprising:
a wireless communication unit;
a user interface;
a distance determination means;
a processor configured to perform various functions and operations;
and a non-transitory computer readable medium in communication with the processor, the computer readable medium comprising one or more programming instructions for causing the processor to:
determine a distance between said control system and said vehicle or house;
prompt a message requesting for unlocking in said user interface if said distance is smaller than a threshold;
communicate with said vehicle or house requesting for unlocking if said prompted message is confirmed.

2. A control method for vehicle and house entry comprising:
determining a distance between said control system and said vehicle or house;
prompting a message requesting for unlocking in said user interface if said distance is smaller than a threshold;
communicating with said vehicle or house requesting for unlocking if said prompted message is confirmed.
